(19) United States
(12) Patent Application Publication
(10) Pub. No.: US 2005/0259061 A1
(43) Pub. Date: Nov. 24, 2005

(54) Electro-optical device, driving circuit thereof, and electronic apparatus

(75) Inventor: Toru Aoki, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/089,147

(22) Filed: Mar. 25, 2005

(30) Foreign Application Priority Data
May 20, 2004 (JP) 2004-150459
Mar. 4, 2005 (JP) 2005-060029

(51) Int. Cl. G09G 3/36

(52) U.S. Cl. 345/96

(57) ABSTRACT

A circuit of driving an electro-optical device includes: a storage unit and a correction unit. The storage unit stores a correction value corresponding to a pixel position of a display section in which pixels are formed so as to correspond to intersections of a plurality of scanning lines and a plurality of source lines which are arranged in a matrix and which performs the pixel display by allowing an image signal supplied to a source line to be applied to a pixel electrode of each pixel via switching elements, the image signal being supplied to the source line by turning on a switching element disposed in the pixel with the scanning signal supplied to the scanning line. The correction unit receives the image signal for polarity reverse driving and independently adding a correction value from the storage unit to an image signal having a positive polarity and an image signal having a negative polarity to supply the image signals to the display section.

### BACKGROUND OF THE INVENTION

1. Technical Field

The present invention relates to an electro-optical device of which flicker or the like has been reduced over the entire display region, a circuit for driving the same, and an electronic apparatus.

2. Related Art

An electro-optical device, for example, such as a liquid crystal display device using liquid crystal as an electro-optical material is widely used, as a display device replacing a cathode ray tube (CRT), for a display portion or a liquid crystal TV, such as various information processing apparatuses.

Such a liquid crystal display device includes, for example, pixel electrodes arranged in a matrix, an element substrate on which switching elements such as thin film transistors (TFTs) connected to the pixel electrodes are disposed, a counter substrate on which counter electrodes corresponding to the pixel electrodes are disposed, and liquid crystal as the electro-optical material filled between these two substrates.

The TFTs are electrically connected to each other by scanning signals (gate signals) supplied via scanning lines (gate lines). When the switching elements are in an electrically conducted state after the scanning signals are applied thereto, an image signal with a voltage in response to a gray-scale level is applied to the pixel electrode via the data line (source line). Then, charges are stored in the pixel electrode and the counter electrode in response to the voltage of the image signal. Even when the scanning signal is removed to make the TFT be in the non-electrically conducted state after charges are stored, the stored state of charges at each electrode is maintained by the capacitance of a liquid crystal layer or a storage capacitor.

As such, when each switching element is driven to control the amount of charges to be stored in response to the gray-scale level, the orientation state of the liquid crystal at each pixel is changed to allow the transmittance of light to be changed, which in turn allows the brightness to be changed at each pixel. Accordingly, it is possible to perform display in response to the gray-scale level.

However, direct current components of applied signals cause the liquid crystal display device to be contaminated due to impurities within liquid crystal cells or cause liquid crystal components to break down, and cause a burn-in phenomenon of the display image to occur. In this case, reverse driving, in which the polarity of the voltage for driving each pixel electrode is generally inverted for every frame of the image signal, is performed. Surface-reverse driving such as the frame reverse driving is performed with the driving voltages whose polarities are equal to each other for all pixel electrodes constituting the image display region to invert the driving voltage for a constant period.

In consideration of the capacitances of the storage capacitor and the liquid crystal layer, charges may be applied to the liquid crystal layer of each pixel only for a portion of the period. Accordingly, when the plurality of pixels arranged in a matrix are driven, scanning signals may be simultaneously applied to the pixels connected to the same scanning line via respective scanning lines, and the image signals may be applied to each pixel via the data lines, and the scanning line for supplying the image signal may be sequentially switched to the next one. That is, the scanning line and the data line may be used in common for the plurality of pixels of the liquid crystal display device, which allows time-division multiplex driving to be implemented.

As such, in consideration of the capacitance in the liquid crystal display device, the driving voltage is applied to the pixel only for a portion of the period. However, the pixel electrode is affected by the potential of the source line due to the charge leakage and the coupling capacitance even when the TFT is in an off-state. Due to the potential variation of the voltage applied to the pixel, the display within the screen is not uniform, and the image quality is significantly degraded in the intermediate gray-scale region.

To avoid such a problem, a reverse driving technique is employed, which is combined with reverse driving processing per frame and line reverse driving for making the polarity of the driving potential different from each other from line to line in the liquid crystal display device. The polarity of the image signal transmitted via the source line is converted in a relatively short period so that the effects of coupling capacitance and charge leakage may be reduced.

However, the image signal supplied via the source line is applied to the pixel electrode via the source and drain path of the TFT. As described above, when the TFT is turned off, the level of the image signal applied to the pixel electrode is lowered to be retained due to the capacitor and the capacitance of the liquid crystal layer until the next writing is carried out. However, at the time of the TFT being turned off, the voltage applied to the pixel electrode is lowered by the voltage retained in the interconnection capacitance and the parasitic capacitance between the gate and source of the TFT, which is so called push-down. Furthermore, due to the channel effect of the TFT, the amount of push-down right after the writing of the negative polarity image signal is larger than that right after the writing of the positive polarity image signal.

Due to such a differential amount of push-down, the effective value of the positive polarity image signal and that of the negative polarity image signal become changed. In general, a voltage applied to the counter electrode (hereinafter, referred to as an LC common voltage) is set to a level where the effective value of the positive polarity image signal matches that of the negative polarity image signal so as not to apply a direct current component to the liquid crystal layer. That is, the more the amount of push-down is increased, the more the LC common voltage for matching the effective value of the positive polarity image signal with that of the negative polarity image signal is decreased.

However, the Y driver for supplying the scanning signal to each scanning line is disposed at one side or both sides 6fthe pixel region in the liquid crystal display device. The waveform of the scanning signal is distorted due to an interconnection resistance or the like when the distance of the pixel having the scanning signal applied from the Y driver is increased. As a result, the more the distance from the Y driver is increased, the less the amount of push-down is decreased. That is, the difference between the amount of push-down of the positive polarity and that of the negative polarity is increased when the distance of the pixel from the Y driver is increased and vice versa. That is, the optimal LC common voltage is changed in response to the screen position.

In addition, the TFT substrate and the counter substrate which constitute the liquid crystal display device generally have a stacked structure, and light components incident on the liquid crystal display device at an angle is subjected to multiple reflection within the stacked structure so that it is irradiated on the channel region or the region adjacent to the channel region of the TFT element. As a result, an optical leakage current occurs which flows toward the gate of the TFT element. The leakage current lowers the level of the positive polarity image signal and maintains the level of the negative polarity image signal. Furthermore, the effect of the optical leakage current is more significant at the time of positive polarity driving than the negative polarity driving. That is, the optimal LC common voltage is lowered due to the occurrence of leakage current.

However, a center portion of an opening region and the surrounding portion have a different amount of optical leakage from each other: the amount of optical leakage is so large at that of the center of the screen. That is, the optimal LC common voltage is changed depending on the screen position.

The LC common voltage is a voltage applied to the common electrode, and is uniform within the screen. Accordingly, the effective value of the voltage applied to the liquid crystal capacitance is actually changed at the time of positive polarity writing and the negative polarity writing due to the effects of push-down and optical leakage in response to the screen position. As a result, regardless of the alternative current driving, a direct current component is applied to the liquid crystal capacitance, which causes the burn-in phenomenon to occur and causes flicker to occur at the time of positive polarity writing and the negative polarity writing so that the display quality becomes significantly degraded.

### SUMMARY

An advantage of the present invention is that it provides an electro-optical device capable of overcoming the degraded display quality resulting from burn-in or flicker, a driving circuit thereof, and an electronic apparatus using the same.

The above advantage of the invention is achieved by an aspect of the driving circuit of the electro-optical device according to the invention, which includes: a storage unit that stores a correction value corresponding to a pixel position of a display section in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line; and a correction unit that receives the image signal for polarity reverse driving and independently adding a correction value from the storage unit to an image signal having a positive polarity and an image signal having a negative polarity to supply the image signals to the display section.

According to this configuration, a correction value corresponding to a pixel position of the display section is stored in the storage unit. The correction unit receives the image signal for polarity reverse driving, reads the corresponding correction value of the pixel position to add it to the image signal of the positive and negative polarity image signals. The same correction value is added to both of the positive polarity image signal and the negative polarity image signal so that the optimal reference voltage may be equivalently corrected without changing the luminance level, which thus allows the uniform display to be implemented over the whole region of the display section. That is, the direct current component may be prevented from being applied to the display section, so that the image display having a high display quality may be implemented without causing burn-in and flicker.

In addition, the correction value corresponds to a differential value between an optimal reference voltage for matching an effective value of the positive polarity image signal to an effective value of the negative polarity image signal at each pixel position and a setting reference voltage set for the display section at each pixel position.

According to this configuration, the correction unit adds the correction value to the image signal, so that the effective value of the positive polarity image signal of the image signal may be equivalently made to be equal to that of the negative polarity image signal. That is, the display section may be driven with the optimal reference voltage setting, so that the direct current component may be prevented from being applied to the display section, which allows the image display having a high display quality to be implemented without causing burn-in and flicker.

In addition, the correction value corresponds to a distance from a center of the display section.

According to this configuration, the optimal reference voltage of the display section may be equivalently uniform within the surface when it is changed in response to the distance from the center of the display section, which allows the image display having a high display quality to be implemented without causing burn-in and flicker.

In addition, the image signal is a digital signal, and the correction value is capable of being set as a value different from the positive polarity image signal and the negative polarity image signal by one bit of the least significant bits of the image signal.

According to this configuration, the optimal reference voltage may be equivalently controlled with an accuracy of one half the LSB of the image signal.

The electro-optical device according to the invention includes: the above-described circuit for driving the electro-optical device; the display section; a scanning line driving circuit of supplying the scanning signal to the scanning line of the display section; and a data line driving circuit of supplying the image signal from the correction unit to the source line of the display section.

According to this configuration, the image signal added with the correction value stored in the storage unit is output from the circuit of driving the electro-optical device. This image signal is written to each pixel by the scanning line driving circuit and the data line driving circuit. For example, the same correction value is added to both of the positive polarity image signal and the negative polarity image signal so that the luminance level of the image signal is not changed and the optimal reference voltage is equivalently corrected. As a result, the image display having a high display quality may be implemented without causing burn-in and flicker.

In addition, the electronic apparatus according to the present invention includes a display unit configured using the above-described electro-optical device.

According to this configuration, the image display having a high display quality may be implemented without causing burn-in and flicker.

### BRIEF DESCRIPTION OF THE DRAWINGS

The invention will be described with reference to the accompanying drawings, wherein like numbers reference like elements, and wherein:

FIG. 1 is an explanatory view illustrating an electro-optical device in accordance with an embodiment of the invention;

FIG. 2 is a block diagram illustrating an electrical configuration of a projector;

FIG. 3 is a block diagram illustrating a configuration of a liquid crystal panel 100R;

FIG. 4 is a timing chart illustrating an operation of a projector;

FIG. 5 is a block diagram illustrating a configuration of a correction circuit;

FIG. 6 is a block diagram illustrating a configuration of a correction amount output section 322;

FIG. 7 is an explanatory view for explaining correction data to be stored in ROM 12;

FIG. 8 is an explanatory view for explaining correction data to be stored in ROM 12;

FIG. 9 is a flow chart illustrating an operation of a correction circuit;

FIG. 10 is a perspective view illustrating a configuration of a computer; and

FIG. 11 is a perspective view illustrating a configuration of a cellular phone.

### DESCRIPTION OF THE EMBODIMENTS

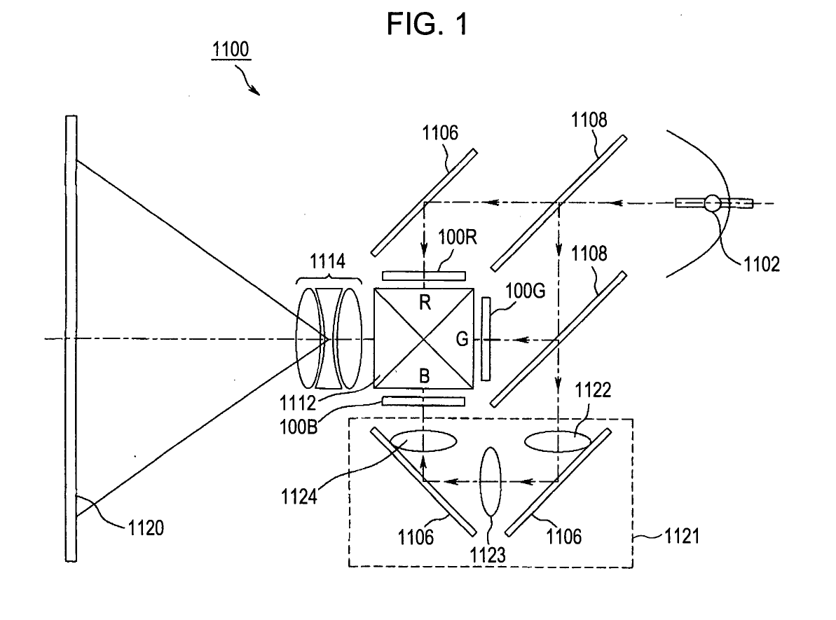

Preferred embodiments of the present invention will now be described with reference to the drawings. FIG. 1 is an explanatory view illustrating an electro-optical device in accordance with an embodiment of the invention. The present embodiment refers to a projector in which light components transmitted by a liquid crystal panel are combined and then enlarged and projected.

Embodiments

First, a configuration of an optical system of the projector will be schematically described with reference to FIG. 1.

Referring to FIG. 1, a lamp unit 1102 composed of a white light source such as a halogen lamp is disposed within a projector 1100. Projection light emitted from the lamp unit 1102 are separated into three primary colors of red (R), green (G), and blue (B) by three internal mirrors 1106 and two internal dichroic mirrors 1108, which are guided to liquid crystal panels 100R, 100G, and 100B corresponding to the respective primary colors.

In this case, image signals of the R, G, and B colors processed by a processing circuit 300 to be described later are supplied to the liquid crystal panels 100R, 100B, and 100G, respectively. Accordingly, the liquid crystal panels 100R, 100B, and 100G serve as optical modulators for generating the images of the primary colors of R, G, and B. Light components modulated by the liquid crystal panels 100R, 100B, and 100G are incident on the dichroic prism 1112 from a three o'clock direction. The R and B light components are refracted while the G light component propagates straight through the dichroic prism 1112. As a result, the combined image of the respective color images is projected onto the screen 1120 via the projection lens 1114. In addition, light components corresponding to the primary colors R, G, and B are made incident on the respective liquid crystal panels 100R, 100B, and 100G by the dichroic mirror 1108, so that a color filter such as a direct view panel is not necessary.

Next, an electrical configuration of the projector 1100 will be described.

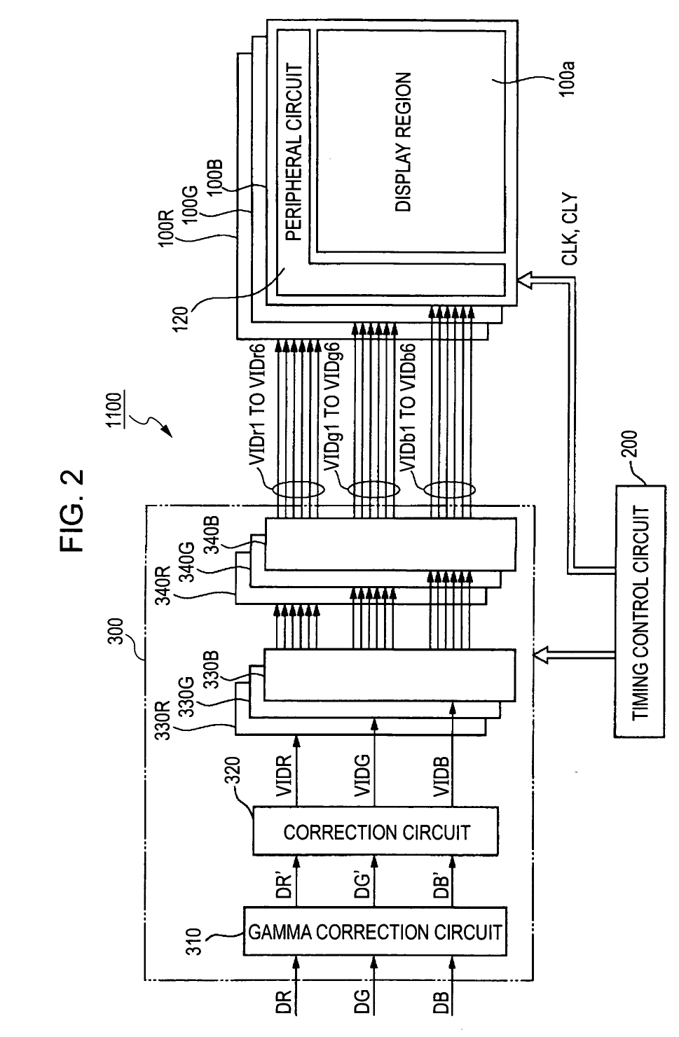

FIG. 2 is a block diagram illustrating an electrical configuration of the projector. The projector 1100 has three liquid crystal panels 100R, 100G, and 100B, a timing control circuit 200, and a processing circuit 300. Among these components, the timing control circuit 200 generates clock signals or timing signals for controlling respective components in response to a vertical scanning signal Vs, a horizontal scanning signal Hs, and a dot clock signal DCLK supplied from a higher-level device.

Meanwhile, the processing circuit 300 includes a gamma correction circuit 310, a correction circuit 320, S/P (serial-parallel) conversion circuits 330R, 330G, and 330B, and inverting amplifying circuits 340R, 340G, and 340B. Among these components, the gamma correction circuit 310 performs gamma correction on the supplied digital image data DR, DG, and DB corresponding to the R, G, and B components so as to make them correspond to the respective display characteristics of the liquid crystal panels 100R, 100G, and 100B so that the image data DR′, DG′, and DB′ are output. The correction circuit 320 performs correction on the image data DR′, DG′, and DB′ per color or per pixel for preventing flicker from occurring while converting the corrected data to be output as image signals VIDR, VIDG, and VIDB. In addition, details of the correction circuit 320 will be described later.

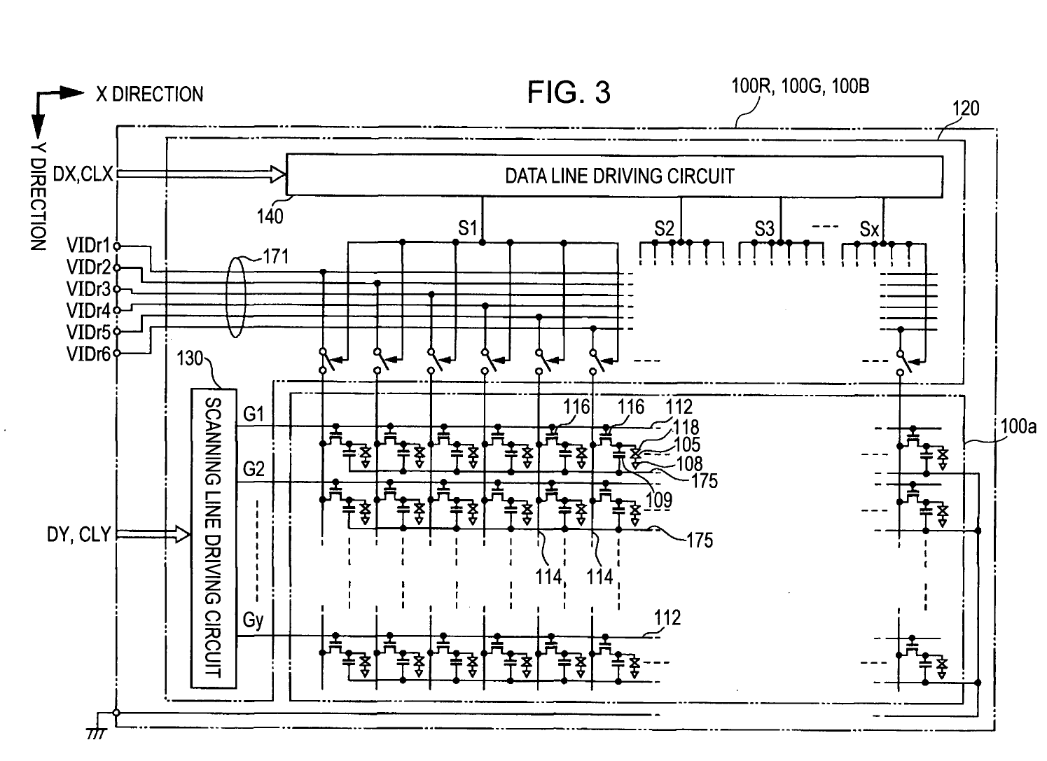

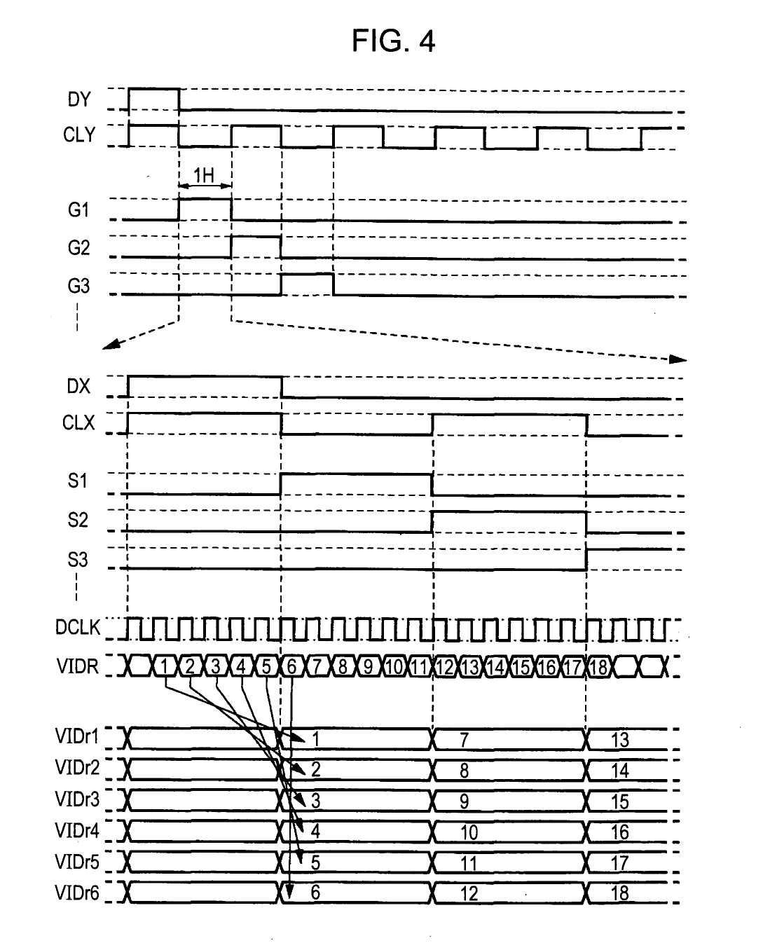

When the image signal VIDR of one line is input, the S/P conversion circuit 330R corresponding to the color R distributes it to six lines and expands (i.e. serial-parallel conversion) it by six times with respect to the time axis, to output the image signal VIDR of one line (See FIG. 4). In this case, the conversion to image signals of six lines is performed in order to lengthen the time for applying the image signal to ensure a sufficient sampling time and charge and discharge time of the image signal in the sampling switch 151, to be described later (see FIG. 3). The inverting amplifying circuit 340R corresponding to color R inverts and amplifies the polarity of the image signal to be supplied to the liquid crystal panel 100R as image signals VIDr1 to VIDr6. Here, the polarity of the image signal refers to a relative polarity based on an LC common voltage, which is a reference voltage.

In addition, the image signal VIDG of color G output from the correction circuit 320 is similarly converted to six lines by the S/P conversion circuit 330G, and is inverted and amplified by the inverting amplifying circuit 340G to be supplied to the liquid crystal panel 100G as image signals VIDg1 to VIDg6. Similarly, the image signal VIDB of the color blue (B) is converted to six lines by the S/P conversion circuit 330B, and is inverted and amplified by the inverting amplifying circuit 340B to be supplied to the liquid crystal panel 100B as image signals VIDb1 to VIDb6.

In addition, the inverting amplifying circuits 340R, 340G, and 340B perform polarity inversion by alternately inverting a voltage level, with a constant potential Vc of the voltage being a reference. In addition, performing the inversion is determined by the manner of applying the image signal to the data line on a scanning line basis, data line basis, or a pixel basis, and its inversion period is set to one horizontal scanning period or the dot clock period. It is hereinafter assumed that the manner is based on the scanning lines for simplicity of description.

Next, the configuration of the liquid crystal panels 100R, 100G, and 100B will be described.

The liquid crystal panels 100R, 100G, and 100B have the same electrical configuration as each other, so that the liquid crystal panel 100R corresponding to the color R will be described as an example in the present embodiment. FIG. 3 is a block diagram illustrating the configuration of the liquid crystal panel 100R. As shown in FIG. 3, a plurality of scanning lines 112 are arranged in the row (X) direction and a plurality of data lines 114 are arranged in the column (Y) direction in the display region 100a of the liquid crystal panel 100. At each intersection between the data lines 112 and the data lines 114, the gate of the TFT 116 serving as a switching element is connected to the scanning line 112 and the source of the TFT 116 is connected to the data line 114, while the drain of the TFT 116 is connected to the rectangular transparent pixel electrode 118. In this case, the pixel electrode 118 faces the counter electrode 108, and the liquid crystal 105 is interposed between these electrodes. That is, the liquid crystal capacitance is formed by interposing the liquid crystal between the pixel electrode and the counter electrode.

A scanning line driving circuit 130, a data line driving circuit 140, and a peripheral circuit 120 composed of sampling switches 151 or the like are disposed in the peripheral region of the display region 100a. Among these components, the scanning line driving circuit 130 sequentially shifts the transmitting pulse DY supplied at the time of initiating the vertical scanning period whenever the logical level of the clock signal CLY transits (rising and falling), and supplies the scanning signals G1, G2, G3, . . . Gy which are exclusively turned on, to each scanning line 112 for each horizontal scanning period 1H, as shown in FIG. 4.

The data line driving circuit 140 outputs the sampling control signals S1, S2, . . . , Sx which have sequentially turned-on potentials, within one horizontal scanning period. In detail, the data line driving circuit 140 sequentially shifts the transmitting pulse DX supplied at the time of initiating the vertical scanning period whenever the logical level of the clock signal CLX transits, and outputs the scanning signals G1, G2, G3, . . . , Gy as sampling control. signals S1, S2, . . . , Sx so as to make them exclusively have turned-on potential as shown in FIG. 4.

The image signals VIDr1 to VIDr6 are supplied via six image signal lines 171 and sampled to each data line 114 in response to the sampling control signals S1, S2, . . . , Sx. In detail, every six data lines 114 forms one block, and the sampling switch 151 connected to one end of the data line 114 that is positioned at the farthest left among six data lines 114 included in the i-th (i=1, 2, . . . , n) block when counted from left of FIG. 3 samples the image signal VIDr1 supplied via the image signal line 171 to be supplied to the corresponding data line 114 when the sampling signal S1 is turned on.

In addition, the sampling switch 151 connected to one end of the second data line 114 among six data lines 114 included in the same i-th (i=1, 2, . . . , n) block samples the image signal VIDr2 to be supplied to the corresponding data line 114 when the sampling signal S1 is turned on. Similarly, the sampling switches 151 connected to respective one ends of the third, fourth, fifth, and sixth data lines 114 among six data lines 114 included in the same i-th block sample the image signals VIDr3, VIDr4, VIDr5, and VIDr6 to be supplied to the corresponding data lines 114 when the sampling signal S1 is turned on.

In addition, the capacitor 109 for contributing to charge accumulation of the liquid crystal capacitance is disposed in parallel to each liquid crystal capacitance in the display region 100a. To detail this, one end of the capacitor 109 is connected to the pixel electrode 118 (drain of TFT 116) while the other is connected by the capacitor line 175 in common. In addition, the capacitor line 175 is grounded to a constant potential (for example, potential LCcom, on-potential Vdd, off-potential Vss or the like) in common.

Next, a detailed configuration of a correction circuit 320 of FIG. 2 will be described.

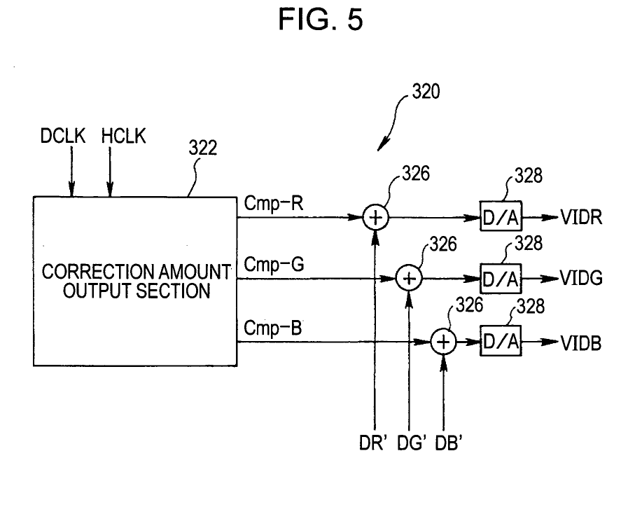

FIG. 5 is a block diagram illustrating a configuration of the correction circuit. Referring to FIG. 5, a correction amount output section 322 outputs the correction data Cmp-R, Cmp-G, and Cmp-B corresponding to respective digital image data DR′, DG′, and DG′ so as to correspond to the coordinate positions in the-display region 100a. In addition, the correction amount output section 322 will be described in detail.

Correction data Cmp-R, Cmp-G, and Cmp-B are supplied to adders 326 corresponding to respective RGB colors while zero data are supplied to the input end B. Each adder 326 adds data from the correction amount output section 322 to the respective original image data DR′, DG′, and DB′ and outputs them. And D/A converters 328 corresponding to respective RGB colors convert data added by the respective adders 326 to analog data and output them as corrected image signals VIDR, VIDG, and VIDB.

In this configuration, the correction data Cmp-R, Cmp-G, and Cmp-B are independently added to the respective image data DR′, DG′, and DB′ for each color. According to the present embodiment, the correction data corresponding to each coordinate position are added to the image data by the changed amount of the optimal LC common voltage which is the optimal reference voltage in response to the position of the display region, so that the optimal LC common voltage may be equivalently obtained.

As such, the correction amount output section 322 generates correction data in response to the coordinate position (pixel position) in the display region 100a and outputs them to prevent degradation of the display quality due to flicker or the like.

Next, the correction amount output section 322 of FIG. 5 will be described in detail.

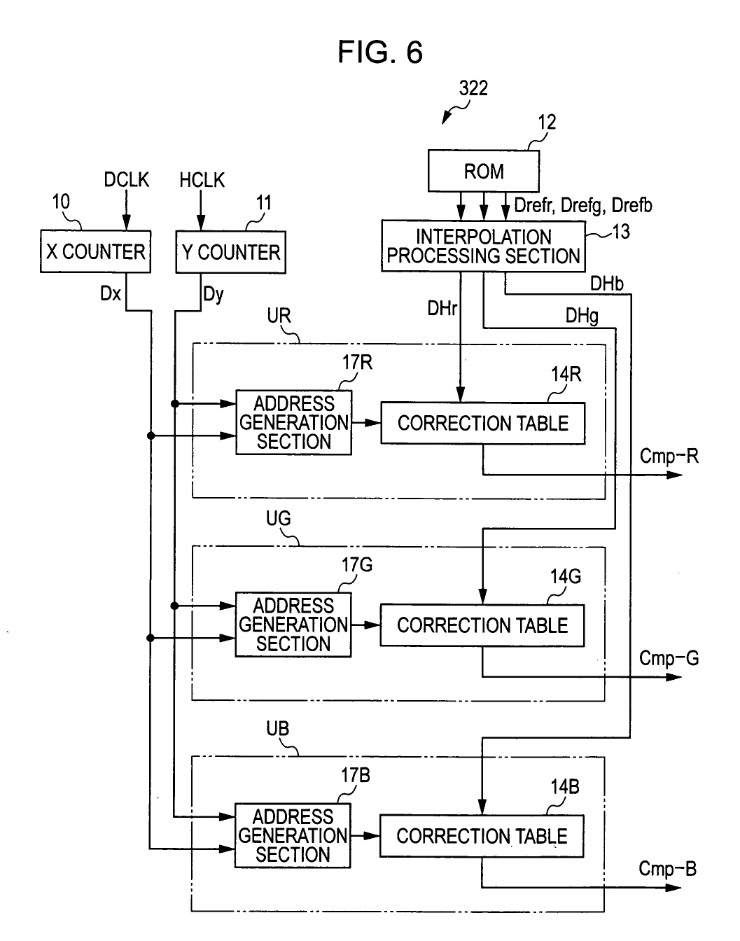

FIG. 6 is a block diagram illustrating a configuration of the correction amount output section 322. As is shown in FIG. 6, the correction amount output section 322 has an X counter 10, a Y counter 11, a read only memory (ROM) 12, an interpolation processing section 13, and correction units UR, UG, and UB.

Among these components, the X counter 10 counts the dot clock signal DCLK which is synchronized with the period of supplying the image data by one dot (pixel), and outputs the X coordinate data Dx indicating the X coordinate of the image data. Meanwhile, the Y counter 11 counts the horizontal clock signal HCLK which is synchronized with horizontal scanning, and outputs the Y coordinate data Dy indicating the Y coordinate of the image data. Accordingly, the dot (pixel) coordinate corresponding to the image data may be identified by referring to the X coordinate data Dx and the Y coordinate data Dy. In addition, the horizontal clock signal HCLK demultiplied by one half is the above-described clock signal CLY. And the dot clock signal DCLK demultiplied by one half is the above-described clock signal CLX.

The ROM 12 is a non-volatile memory, and outputs correction data Drefr, Drefg, and Drefb corresponding to RGB colors when the power is supplied to the projector 1100. These correction data Drefr, Drefg, and Drefb are sources of correction data for correcting flicker or the like.

In addition, when the respective RGB colors are discriminated from each other for the correction data, R color is denoted by Drefr, B color is denoted by Drefb, and B color is denoted by Drefb, and Dref is denoted when it is not necessary to discriminate the respective RGB colors.

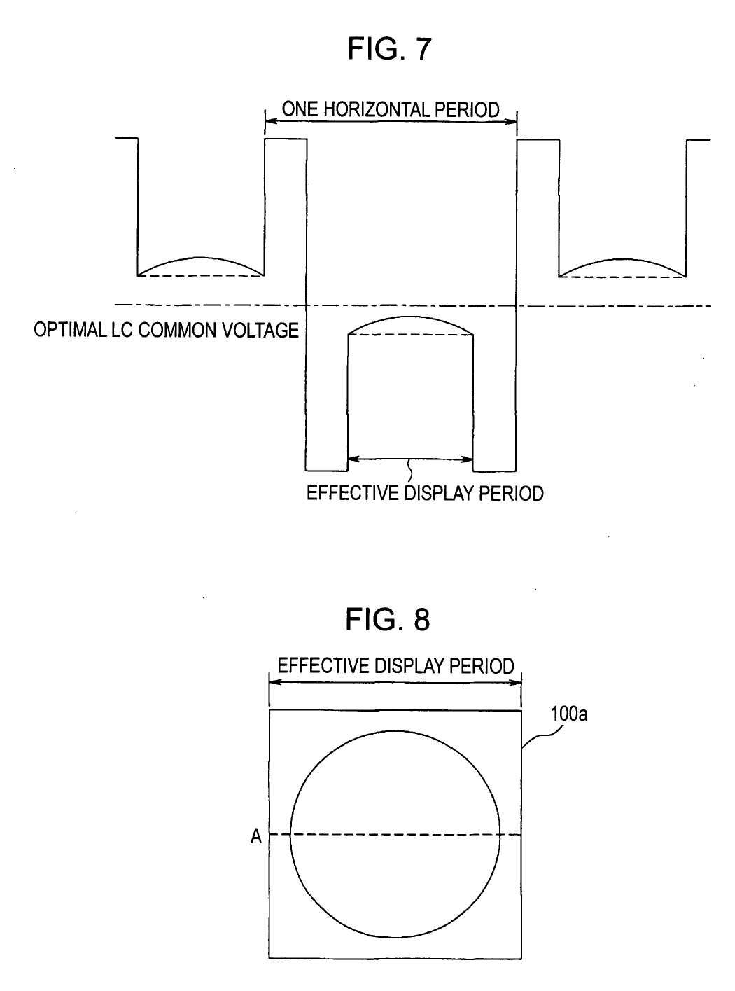

FIGS. 7 and 8 are explanatory views for explaining correction data stored in the ROM 12. As described above, due to the optical leakage and push-down or the like, the optimal LC common voltage is different from each position within the display region 100a. According to the present embodiment, the optimal LC common voltage is set to a predetermined constant voltage (hereinafter, referred to as the set LC common voltage) while the correction data corresponding to the difference between the optimal LC common voltage and the set LC common voltage, which is a set reference voltage for each portion within the display region 100a, are used.

FIG. 7 is a view illustrating the image signal after correction. A long one-dotted line indicates the set LC common voltage. The effective display period of FIG. 7 has a signal for a predetermined horizontal line of the display region 100a, for example, corresponds to the line A at the center of the screen of FIG. 8. FIG. 8 illustrates the display region 100a.

The optimal LC common voltage is set based on the peripheral pixels of the display region 100a as shown in FIG. 8. That is, the set LC common voltage is set so as to match the effective value of the positive polarity image signal with that of the negative polarity image signal in the periphery of the display region 100a. However, the optimal LC common voltage at the center of the display region 100a is lower than that of the peripheral portions due to the optical leakage current or the like as described above. The circular region of FIG. 8 indicates the range of the relatively high optimal LC common voltage within the display region 100a.

According to the present embodiment, correction data indicating the difference between the optimal LC common voltage and the set LC common voltage per each coordinate position of the display region 100a are stored in the ROM 12. In this case, in order to reduce the load of computing the correction data and the memory capacity, instead of setting the correction data per each pixel, the display region 100a may be divided into a plurality of regions in response to the distance from the center of the display region to the periphery to set one correction data per each region. In this case, the image signal of the pixel included in each region is subjected to common correction. In addition, even when the correction data of each region is used, the interpolation processing section 13 may correct (interpolate) the correction data in response to the distance from the center of the display region 100a so that the image signal may be corrected per each pixel.

That is, the interpolation processing section 13 uses the correction data set per each region to calculate the correction data at each pixel position in response to the distance from the center of the display region 100a. The interpolation processing section 13 outputs the calculated correction data of each pixel position to the correction tables 14R to 14B as the correction data DHr, DHg, and DHb, respectively.

In addition, the correction data is only subjected to the change of the optimal LC common voltage within the surface due to the optical leakage and the push-down in regardless of the polarity of the image signal, so that it is set, for example, in response to the distance from the center of the display region 100a.

In addition, the correction data for every coordinate positions of the display region 100a may be stored in the ROM 12. In this case, the correction data itself for every coordinate position may be used to correct the image signals of whole pixels.

Alternatively, as shown in FIG. 8, in the two regions such as the circular region and its peripheral region, one correction data may be set to each region. When the correction data stored in the ROM 12 corresponds to each pixel position, or when correction corresponding to the correction data is carried out, the interpolation processing section 13 may be omitted.

The correction units UR and UB have correction tables 14R to 14B and address generation sections 17R to 17B, respectively. The correction tables 14R to 14B store correction data DHr, DHg, and DHb corresponding to respective pixel positions from the interpolation processing section 13 to the respective addresses corresponding to the pixel positions. The address generation sections 17R to 17B receive the coordinate data Dx and Dy to designate addresses corresponding to the correction tables 14R to 14B.

Accordingly, the correction tables 14R to 14B output the correction data Cmp-R to Cmp-B at the timing corresponding to the respective pixel positions of the input image signal.

Next, an operation of the correction circuit 320 will be described.

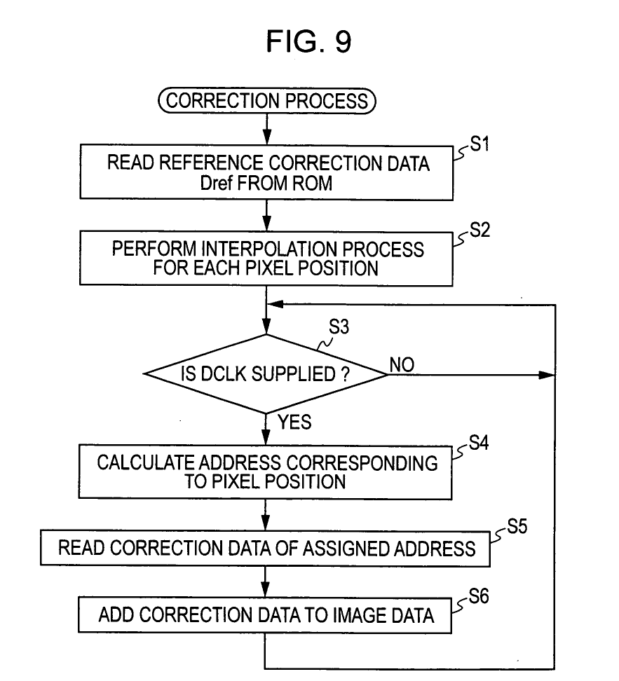

FIG. 9 is a flow chart illustrating an operation of the correction circuit.

In the present embodiment, due to the optical leakage and the push-down or the like, the optimal LC common voltage is lower in the center portion of the display region 100a than its peripheral region. And the set LC common voltage is set with the optimal LC common voltage near the peripheral portion of the display region 100a as a reference. Accordingly, the correction data corresponding to the peripheral portion of the display region 100a are set to have a correction value of zero, and are set to a value applying large correction amount as much as the correction data corresponding to pixels close to the center of the display region 100a. The change of the optimal LC common voltage within the surface due to the optical leakage and the push-down becomes the reference at the time of building the system so that the correction data is already stored in the ROM 12 based on the change of the optimal LC common voltage within the surface.

First, when a power is supplied to the projector 1100, correction data Dref (Drefr, Drefg, and Drefb) corresponding to respective reference coordinates are read out from the Rom 12 (step S1).

The interpolation processing section 13 interpolates the correction data Drefr, Drefg, and Drefb to generate the correction data DHr, DHg, and DHb of respective pixel positions in response to distance from the center of the display region 100a (step S2). The generated correction data DHr, DHg, and DHb are supplied to the respective correction tables 14R to 14B.

The correction data DHr, DHg, and DHb of respective pixel positions are stored in addresses corresponding to the respective correction tables 14R, 14G, and 14B. In the next step S3, it is determined whether the dot clock signal DCLK and the horizontal clock signal HCLK are supplied in response to the corresponding image data DR′, DG′, and DB′ of one dot (pixel). When the determination is negative, processing returns to the step S3 to be in stand-by mode.

Alternatively, when the determination of step S3 is positive, the X counter 10 and the Y counter 11 count up the input DCLK respectively and update the horizontal coordinate data of the display region 100a. The counted values of the X counter 10 and the Y counter 11 indicate where the image data DR′, DG′, and DB′ of the current time correspond to respective coordinate positions in the display region 100a.

The X data coordinate Dx and the Y data coordinate Dy output from the X counter 10 and the Y counter 11 respectively may be supplied to the address generation sections 17R to 17B, so that the address generation sections 17R to 17B may generate addresses of respective correction tables 14R to 14B corresponding to the pixel positions based on the input image data (step S4). Correction data corresponding to respective pixel positions on the display region 100a of the input image data are read out from the respective correction tables 14R to 14B, which are output as correction data Cmp-R to Cmp-B, respectively (step S5).

The correction data Cmp-R to Cmp-B are supplied to the adders 326 of the respective axes to be added to the input image data DR′ to DB′. Outputs of the adders 326 of the respective axes are analog-converted by the D/A converters 328 of respective axes to be output as image signals VIDR to VIDB. In order to carry out the same processing for the image data DR′, DG′, and DB′ of the next one dot, the processing returns to the step S3.

As a result, the image signal supplied to the source line is for example shown in FIG. 7. The dash line of FIG. 7 indicates the image signal before correction. The correction as shown in FIG. 7 is carried out such that the level of signal corresponding to the center of the screen is increased in the positive direction for any one of the positive and negative polarity image signals. And the same correction value is used in regardless of the polarity.

As such, according to the present embodiment, in regardless of the positive polarity or the negative polarity of the image signal, the calculated correction value in response to only the changed optimal LC common voltage within the surface is added to the positive and negative polarity image signals to make the effective values of the image signals equal to each other and to use the equivalently set LC common voltage as the optimal LC common voltage over whole pixels. Accordingly, the degradation of the display quality due to burn-in, flicker or the like may be suppressed.

In addition, when the correction data are added to any one of the positive polarity image signal and the negative polarity image signal, or when the correction data different from each other are added to the positive and negative polarity image signals, there occurs a shortcoming that the luminance level is changed. Accordingly, the correction data having the same level are added to both of the positive and negative polarity image signals, so that the luminance level is not changed even when the correction is carried out in accordance with the present embodiment.

However, when the image signal is subjected to digital processing to carry out the correction as shown in the present embodiment, the equivalent optimal LC common voltage has one bit of the least significant bits (LSBs) of the image signal as the minimum control unit. For example, when one LSB corresponds to 10 mV, the optimal LC common voltage is equivalently increased by 10 mV when the same correction value is added to each of the positive and negative polarity image signals.

Accordingly, it is also possible to set the correction value for the positive polarity image signal and the correction value for the negative polarity image signal to a value different from the LSB of the image signal by one bit in the present embodiment. For example, when the positive polarity image signal is incremented by one LSB and the correction amount of the negative polarity image signal is set to zero, the optimal LC common voltage is equivalently increased by 0.5LSB. For example, when one LSB corresponds to 10 mV, the optimal LC common voltage is equivalently increased by 5 mV in the present embodiment, so that the control accuracy may be enhanced by making the minimum control unit of the optimal LC common voltage one half.

Electronic Apparatus

Next, an example in which the above-described processing circuit is applied to an electronic apparatus other than the projector will be described.

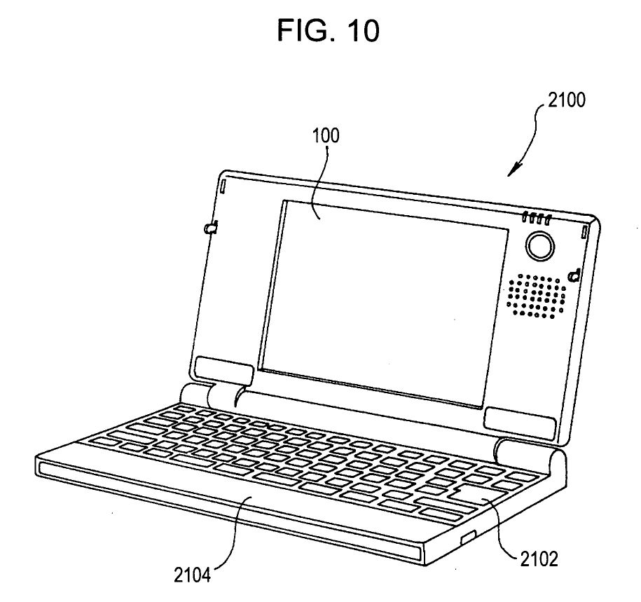

First, an example in which the above-described processing circuit is applied to the display section of the mobile computer will be described. FIG. 10 is a perspective view illustrating the configuration of the computer. Referring to FIG. 10, the computer 2100 includes a main body 2104 having a keyboard 2102, and a liquid crystal panel 100. In addition, a backlight unit for enhancing the visibility (not shown) is disposed on the rear surface of the liquid crystal panel 100.

In this case, the above-described projector 1100 has three plates of liquid crystal panels 100R, 100G, and 100B corresponding to respective colors, however, the liquid crystal panel 100 has a color filter to display each color. Accordingly, the image signals VIDr1 to VIDr6, VIDg1 to VIDg6, and VIDb1 to VIDb6 are not parallel supplied to the liquid crystal panel 100 but in time-division manner. In this case, as is done with the above-described correction circuit 320, the same correction is performed on the positive polarity image signal and the negative polarity image signal in response to distance from the center of the display region, so that burn-in phenomena and flicker may be properly reduced over the whole display region.

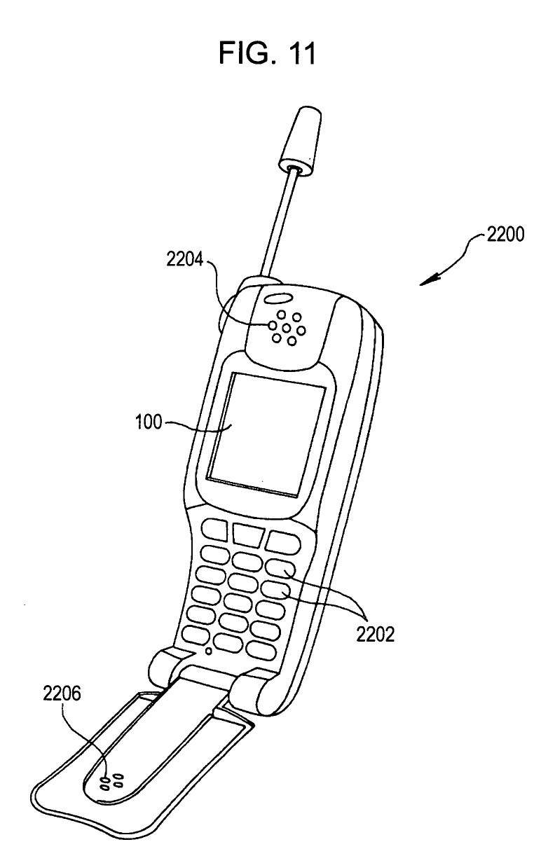

Next, an example which has applied the above-described processing circuit to a display section of a cellular phone is described. FIG. 11 is a perspective view illustrating a configuration of the cellular phone. Referring to FIG. 11, the cellular phone 2200 has a plurality of manipulating buttons 2202, a receiver 2204, a sender 2204, and a liquid crystal panel 100 used as the display section. The liquid crystal panel 100 displays each color of Red, Green, and blue colors (RGB) using a color filter, however, it may perform the gray-scale display of the white color only. When the gray-scale display is carried out for the white color, the image process circuit has not components for three primary colors but a component for a single color.

In addition to the electronic apparatuses described with reference to FIGS. 10 and 11, a liquid crystal TV, view-finder type, or monitor direct view type video tape recorder, a car navigation device, a pager, an electronic note, a calculator, a word processor, a workstation, a picture phone, a point of sale (POS) terminal, a device having a touch panel, and so forth may be employed. And the invention may also be applied to these various electronic apparatuses.

1. A circuit for driving an electro-optical device, comprising:
a storage unit that stores a correction value corresponding to a pixel position of a display section in which pixels are formed so as to correspond to intersections of a plurality of scanning lines and a plurality of source lines which are arranged in a matrix and which performs pixel display by allowing an image signal supplied to a source line to be applied to a pixel electrode of each pixel via switching elements, the image signal being supplied to the source line by turning on a switching element disposed in the pixel with the scanning signal supplied to the scanning line; and
a correction unit that receives the image signal for polarity reverse driving and independently adding a correction value from the storage unit to an image signal having a positive polarity and an image signal having a negative polarity to supply the image signals to the display section.

2. The circuit of driving an electro-optical device according to claim 1, wherein the correction value corresponds to a differential value between an optimal reference voltage for matching an effective value of the positive polarity image signal to an effective value of the negative polarity image signal at each pixel position and a setting reference voltage set for the display section at each pixel position.

3. The circuit of driving an electro-optical device according to claim 1, wherein the correction value corresponds to a distance from a center of the display section.

4. The circuit of driving an electro-optical device according to claim 1, wherein the image signal is a digital signal, and the correction value is set as a value different from the positive polarity image signal and the negative polarity image signal by one bit of the least significant bits of the image signal.

5. An electro-optical device, comprising:
a circuit that drives the electro-optical device claimed in claim 1;
a display section;
a scanning line driving circuit that supplies a scanning signal to a scanning line of the display section; and
a data line driving circuit that supplies an image signal from the correction unit to a source line of the display section.

6. An electronic apparatus comprising a display unit configured using an electro-optical device claimed in claim 5.
